(19) United States
(12) Patent Application Publication
(10) Pub. No.: US 2008/0026109 A1
(43) Pub. Date: Jan. 31, 2008

(54) Sweetened Oil Compositions and Methods of Making

(75) Inventor: Jesus Ruben Abril, Westminster, CO (US)

Correspondence Address: SHERIDAN ROSS PC, 1560 BROADWAY, SUITE 1200, DENVER, CO, 80202, US

(73) Assignee: MARTEK BIOSCIENCES CORPORATION, Columbia, MD (US)

(21) Appl. No.: 11/770,622

(22) Filed: Jun. 28, 2007

Related U.S. Application Data
(60) Provisional application No. 60/806,222, filed on Jun. 29, 2006.

(51) Int. Cl. A23D 7/005; A23L 1/22; A23L 1/236; A23L 1/27; A23L 1/30; A23L 1/302; C11B 5/00

(52) U.S. Cl. 426/72; 426/103; 426/250; 426/533; 426/541; 426/548; 426/602

(57) ABSTRACT

Sweetened oil compositions, and methods for their preparation, comprising long chain polyunsaturated fatty acids are provided. The oil compositions are sweetened with a high-intensity sweetener, and preferably a peptide based sweetener. Particularly, omega-3 long chain polyunsaturated fatty acids, omega-6 long chain polyunsaturated fatty acids, and mixtures thereof are utilized in the compositions and methods.

### CROSS-REFERENCE TO RELATED TO RELATED APPLICATIONS

This application claims the benefit of priority under 35 U.S.C. § 119(e) of U.S. Provisional Application Ser. No. 60/906,222, filed Jun. 29, 2006, the disclosure of which is incorporated by reference herein in its entirety.

### FIELD OF THE INVENTION

The invention relates to sweetened oil compositions, and methods for their preparation, comprising long chain polyunsaturated fatty acids, and particularly, omega-3 long chain polyunsaturated fatty acids, omega-6 long chain polyunsaturated fatty acids, and mixtures thereof.

### BACKGROUND OF THE INVENTION

It is desirable to increase the dietary intake of the beneficial omega-3 polyunsaturated fatty acids (omega-3 PUFA), and omega-3 long chain polyunsaturated fatty acids (omega-3 LC-PUFA). Other beneficial nutrients are omega-6 long chain polyunsaturated fatty acids (omega-6 LC-PUFA). Omega-3 PUFAs are recognized as important dietary compounds for preventing arteriosclerosis and coronary heart disease, for alleviating inflammatory conditions, cognitive impairment and dementia related diseases and for retarding the growth of tumor cells. One important class of omega-3 PUFAs is omega-3 LC-PUFAs. Omega-6 LC-PUFAs serve not only as structural lipids in the human body, but also as precursors for a number of factors in inflammation such as prostaglandins, leukotrienes, and other oxylipins.

Fatty acids are carboxylic acids and are classified based on the length and saturation characteristics of the carbon chain. Short chain fatty acids have 2 to about 6 carbons and are typically saturated. Medium chain fatty acids have from about 6 to about 16 carbons and may be saturated or unsaturated. Long chain fatty acids have from about 18 to 24 or more carbons and may also be saturated or unsaturated. In longer chain fatty acids there may be one or more points of unsaturation, giving rise to the terms “monounsaturated” and “polyunsaturated,” respectively. Long chain PUFAs (LC-PUFAs) are of particular interest in the present invention.

LC-PUFAs are categorized according to the number and position of double bonds in the fatty acids according to a well understood nomenclature. There are two main series or families of LC-PUFAs, depending on the position of the double bond closest to the methyl end of the fatty acid: the n-3 (or ω-3 or omega-3) series contains a double bond at the third carbon, while the n-6 (or ω-6 or omega-6) series has no double bond until the sixth carbon. Other series, e.g., omega-9, also exist. Thus, docosahexaenoic acid (“DHA”) has a chain length of 22 carbons with 6 double bonds beginning with the third carbon from the methyl end and is designated “22:6(n-3)”. Other important LC-PUFAs include eicosapentaenoic acid C20:5(n-3) (EPA), omega-3 docosapentaenoic acid C22:5(n-3) (DPAn-3), omega-6 docosapentaenoic acid C22:5(n-6) (DPAn-6), arachidonic acid C20:4(n-6) (ARA), stearidonic acid, linolenic acid, alpha linolenic acid (ALA), gamma linolenic acid (GLA), conjugated linolenic acid (CLA).

De novo or “new” synthesis of the omega-3 and omega-6 fatty acids such as DHA and ARA does not occur in the human body; however, the body can convert shorter chain fatty acids to LC-PUFAs such as DHA and ARA although at very low efficiency. Both omega-3 and omega-6 fatty acids must be part of the nutritional intake since the human body cannot insert double bonds closer to the omega end than the seventh carbon atom counting from that end of the molecule. Thus, all metabolic conversions occur without altering the omega end of the molecule that contains the omega-3 and omega-6 double bonds. Consequently, omega-3 and omega-6 acids are two separate families of essential fatty acids since they are not interconvertible in the human body.

Over the past twenty years, health experts have recommended diets lower in saturated fats and higher in polyunsaturated fats. While this advice has been followed by a number of consumers, the incidence of heart disease, cancer, diabetes and many other debilitating diseases has continued to increase steadily. Scientists agree that the type and source of polyunsaturated fats is as critical as the total quantity of fats. The most common polyunsaturated fats are derived from vegetable matter and are lacking in long chain fatty acids (most particularly omega-3 LC-PUFAs). In addition, the hydrogenation of polyunsaturated fats to create synthetic fats has contributed to the rise of certain health disorders and exacerbated the deficiency in some essential fatty acids. Indeed, many medical conditions have been identified as benefiting from an omega-3 supplementation. These include acne, allergies, Alzheimer's, arthritis, atherosclerosis, breast cysts, cancer, cystic fibrosis, diabetes, eczema, hypertension, hyperactivity, intestinal disorders, kidney dysfunction, leukemia, and multiple sclerosis. Of note, the World Health Organization has recommended that infant formulas be enriched with omega-3 and omega-6 fatty acids.

The polyunsaturates derived from meat contain significant amounts of omega-6 but little or no omega-3. While omega-6 and omega-3 fatty acids are both necessary for good health, they are preferably consumed in a balance of about 4:1. Today's Western diet has created a serious imbalance with current consumption on average of 20 times more omega-6 than omega-3. Concerned consumers have begun to look for health food supplements to restore the equilibrium. Principal sources of omega-3 are flaxseed oil and fish oils. The past decade has seen rapid growth in the production of flaxseed and fish oils. Both types of oil are considered good dietary sources of omega-3 polyunsaturated fats. Flaxseed oil contains no EPA, DHA, or DPA but rather contains linolenic acid—a building block that can be elongated by the body to build longer chain PUFAs. There is evidence, however, that the rate of metabolic conversion can be slow and unsteady, particularly among those with impaired health. Fish oils vary considerably in the type and level of fatty acid composition depending on the particular species and their diets. For example, fish raised by aquaculture tend to have a lower level of omega-3 fatty acids than fish from the wild.

PUFAs can be extracted from microbial sources for use in nutritional and/or pharmaceutical products. For example, DHA-rich microbial oil is manufactured from the dinoflagellate Crypthecodinium cohnii and ARA-rich oil is manufactured from the filamentous fungus Mortierella alpina, both for use as nutritional supplements and in food products such as infant formula. Similarly, DHA-rich microbial oil from Schizochytrium is manufactured for use as a nutritional supplement or food ingredient. Typically, the LC-PUFAs are extracted from biomass and purified. The extracted and purified oils can be further processed to achieve specific formulations for use in food products (such as a dry powder or liquid emulsion).

Due to the scarcity of sources of omega-3 LC-PUFAs, typical home-prepared and convenience foods are low in both omega-3 PUFAs and omega-3 LC-PUFAs, such as docosahexaenoic acid, docosapentaenoic acid, and eicosapentaenoic acid. In light of the health benefits of such omega-3 LC-PUFAs, it would be desirable to supplement foods with such fatty acids.

While foods and dietary supplements prepared with LC-PUFAs may be healthier, they also have an increased vulnerability to rancidity. Rancidity in lipids, such as unsaturated fatty acids, is associated with oxidation off-flavor development. The oxidation off-flavor development involves food deterioration affecting flavor, aroma, and the nutritional value of the particular food. A primary source of oxidation off-flavor development in lipids, and consequently the products that contain them, is the chemical reaction of lipids with oxygen. The rate at which this oxidation reaction proceeds has generally been understood to be affected by factors such as temperature, degree of unsaturation of the lipids, oxygen level, ultraviolet light exposure, presence of trace amounts of pro-oxidant metals (such as iron, copper, or nickel), lipoxidase enzymes, and so forth.

The susceptibility and rate of oxidation of the unsaturated fatty acids can rise dramatically as a function of increasing degree of unsaturation in particular. In this regard, EPA and DHA contain five and six double bonds, respectively. This high level of unsaturation renders the omega-3 fatty acids readily oxidizable. The natural instability of such oils gives rise to unpleasant odor and unsavory flavor characteristics even after a relatively short period of storage time.

This instability has been addressed in various ways. For example, antioxidants have been added to LC-PUFA oils. The odor and flavor of oils has been masked by various agents, such as a taste masking agent such as vanillin and an odor masking agent such as a fruit, citrus or mint oil have been described. In the case of sweeteners or other additives which are not lipid soluble, additional processing steps and/or ingredients are required to incorporate the sweetener into the oil. For example, foaming agents, emulsifiers and/or other stabilizers must be added, or the oils must be encapsulated or otherwise manipulated.

The present inventors have recognized a need to provide an LC-PUFA oil which has been sweetened, particularly for use in food and other nutritional applications, which is stable to oxidation, which does not include additional stabilizing ingredients, and in which minimal handling is required.

### SUMMARY OF THE INVENTION

The present invention provides a sweetened oil composition comprising an oil comprising at least one LC-PUFA and a high-intensity sweetener, wherein the oil composition does not contain stabilizing agents. The present invention also provides a method for producing a sweetened oil composition comprising contacting an oil comprising at least one LC-PUFA with a high-intensity sweetener in the absence of stabilizing agents to form the sweetened oil composition. The present invention also provides an encapsulated product comprising an oil comprising at least one LC-PUFA and a non-hydrated high-intensity sweetener, wherein the oil composition does not contain stabilizing agents.

In some embodiments the high-intensity sweetener is non-hydrated.

In some embodiments the high-intensity sweetener is a micronized sweetener. In further embodiments, the micronized sweetener has an average particle size less than about 50 μm, or less than about 25 μm, or less than about 10 μm, or less than about 5 μm, or less than about 1 μm, or less than about 0.75 μm, or less than about 0.5 μm, or less than about 0.25 μm, or less than about 0.1 μm.

In some embodiments of the method, the method further comprises micronizing the sweetener prior to contacting it with the oil comprising at least one LC-PUFA.

In some embodiments, the high-intensity sweetener comprises sucralose, saccharine, cyclamates, aspartame, neotame, acesulfame potassium, alitame, thaumatin, dihydrochalcone, stevioside, glycyrrhizin, monellin, salts of the foregoing or mixtures thereof. In some embodiments, the high-intensity sweetener comprises an amino acid based sweetener. In further embodiments, the high-intensity sweetener is aspartame, neotame, or alitame.

In some embodiments, the high-intensity sweetener is present in amounts between about 0.01% by weight and about 3% by weight, and in other embodiments, is present in amounts between about 0.1% by weight and about 1.5% by weight.

In some embodiments, the sweetened oil composition has an oxidative stability index greater than the oxidative stability index of the oil comprising at least one LC-PUFA. In further embodiments, the oxidative stability index is at least about 5% greater than the oxidative stability index of the oil comprising at least one LC-PUFA, or at least about 10% greater than the oxidative stability index of the oil comprising at least one LC-PUFA, or at least about 15% greater than the oxidative stability index of the oil comprising at least one LC-PUFA, or at least about 20% greater than the oxidative stability index of the oil comprising at least one LC-PUFA, or at least about 30% greater than the oxidative stability index of the oil comprising at least one LC-PUFA, or at least about 50% greater than the oxidative stability index of the oil comprising at least one LC-PUFA, or at least about 100% greater than the oxidative stability index of the oil comprising at least one LC-PUFA, or at least about 200% greater than the oxidative stability index of the oil comprising at least one LC-PUFA.

In one embodiment, the sweetened oil composition comprises an oil comprising at least one LC-PUFA, and a high-intensity sweetener, wherein the oil composition does not contain stabilizing agents, and wherein the sweetened oil composition has an oxidative stability index of at least about 25% greater than the oxidative stability index of the oil comprising at least one LC-PUFA. In further embodiments, the oxidative stability index is at least about 30% greater than the oxidative stability index of the oil comprising at least one LC-PUFA, or at least about 50% greater than the oxidative stability index of the oil comprising at least one LC-PUFA, or at least about 100% greater than the oxidative stability index of the oil comprising at least one LC-PUFA, or at least about 200% greater than the oxidative stability index of the oil comprising at least one LC-PUFA.

In some embodiments, the high-intensity sweetener comprises less than about 5% by weight water before combination with the oil.

In other embodiments, the LC-PUFA has a carbon chain length of at least 20, or has at least three double bonds, or is docosahexaenoic acid, eicosapentaenoic acid, omega-3 docosapentaenoic acid, omega-6 docosapentaenoic acid, arachidonic acid, stearidonic acid, linolenic acid, alpha linolenic acid, gamma linolenic acid, conjugated linolenic acid, or mixtures thereof.

In some embodiments, the oil comprising at least one LC-PUFA is a microbial oil, a plant seed oil, or an aquatic animal oil.

In further embodiments, the oil comprising at least one LC-PUFA is a microbial oil from a microorganism of a genus of Schizochytrium, Thraustochytrium, Aplanochytrium, Japonochytrium, Althornia, Elina, Crypthecodinium, or Mortierella. In still further embodiments, the oil comprising at least one LC-PUFA is a microbial oil from a microorganism of a genus of Thraustochytrium, Schizochytrium, Crypthecodinium, or Mortierella.

In other embodiments, the oil comprising at least one LC-PUFA is a plant seed oil derived from an oil seed plant that has been genetically modified to produce long chain polyunsaturated fatty acids.

In some embodiments, the sweetened oil composition of claim 1 further comprises at least one additional component including antioxidants, flavors, flavor enhancers, pigments, vitamins, minerals, prebiotic compounds, or combinations thereof.

The present invention also provides a product comprising any of the above-mentioned sweetened oil compositions or encapsulated products. The product includes a food product, a nutritional product or a medical product.

In some embodiments of the methods, the step of contacting is conducted at about room temperature (i.e., about 20 C). In other embodiments, the step of contacting is conducted at a temperature above room temperature, and in further embodiments, the step of contacting is conducted at a temperature of between about 35° C. and about 55° C.

In some embodiments of the methods, an excess of the high-intensity sweetener is contacted with the oil. The method can further comprise separating the excess high-intensity sweetener from the resulting sweetened oil composition. In further embodiments, the excess of the high-intensity sweetener is contacted with the oil for at least about 5 minutes before the step of separating is conducted. In still further embodiments, the step of separating is selected from the group consisting of decanting, centrifuging, and filtering.

In some embodiments of the methods, the step of contacting comprises passing the oil comprising at least one LC-PUFA over a column comprising the non-hydrated high-intensity sweetener and recovering sweetened oil composition from the column.

In some embodiments of the methods, the step of contacting comprises agitating the oil comprising at least one LC-PUFA and non-hydrated high-intensity sweetener.

In some embodiments of the encapsulated product the product was encapsulated by a process of spray-drying, fluid bed drying, drum (film) drying, coacervation, interfacial polymerization, fluid bed processing, pan coating, spray gelation, ribbon blending, spinning disk, centrifugal coextrusion, inclusion complexation, emulsion stabilization, spray coating, extrusion, liposome nanoencapsulation, supercritical fluid microencapsulation, suspension polymerization, cold dehydration processes, spray cooling/chilling (prilling), evaporative dispersion processes, or methods that take advantage of differential solubility of coatings at varying temperatures.

### BRIEF DESCRIPTION OF THE DRAWINGS

FIG. 1 shows OSI value vs. percent aspartame for a sweetened oil composition of the present invention.

FIG. 2 shows OSI value vs. percent neotame for a sweetened oil composition of the present invention.

### DETAILED DESCRIPTION OF THE INVENTION

The invention provides oil compositions sweetened without the use of stabilizing agents. In some embodiments, the sweetened oil composition comprises an oil comprising at least one long chain polyunsaturated fatty acid, or LC-PUFA, and a high-intensity sweetener, wherein the oil composition does not contain stabilizing agents. As used herein, reference to a long chain polyunsaturated fatty acid or LC-PUFA, refers to a polyunsaturated fatty acid having 18 or more carbons. While not wishing to be bound by theory, it is believed that by using a high-intensity sweetener that is minimally soluble in the oil, the oil is imparted with the desirable amount of sweetener either by suspending or dissolving the high-intensity sweetener in the oil. In this manner, a pleasant tasting and desirable sweetened oil is provided without the need for emulsifying or suspension agents, and/or without the need to hydrate the sweetening agent. As used herein, a stabilizing agent is a compound or composition that aids or increases the amount of sweetener that can be maintained in an oil composition. Examples of stabilizing agents include emulsifying agents, and suspension agents. It should be noted that while reference is made herein to oxidative stability, components that impart or improve oxidative stability (e.g., antioxidants) are generally not synonymous with “stabilizing agents” (e.g., emulsifying agents, suspension agents) as used herein. While the compositions and methods of the present invention utilize a high-intensity sweetener, for the sake of convenience and brevity, such high-intensity sweeteners will be referred to herein either as “high-intensity sweeteners,” or simply “sweeteners.” High-intensity sweeteners can provide the sweetness of sugar (although often with a slightly different taste), but since they are many times sweeter than sugar, only a small amount is needed to replace the sugar. Additionally, it should be noted that the high-intensity sweeteners of the present sweetened oil compositions do not increase the caloric value of the oil.

This invention also provides sweetened microbial biomass and a process for producing such sweetened biomass. In some embodiments, the microorganism making up the biomass comprises at least one LC-PUFA. Microorganisms comprising at least one LC-PUFA are described herein. The biomass may be wet (including frozen) or dry.

In general in the processes of the invention, a microorganism is cultivated in a suitable nutrient medium under appropriate conditions of, e.g. temperature and pH. The pH should be an appropriate physiological pH for the microorganism under cultivation. Cultivation may be in batch, fed batch or continuous culture. A particular process of the present invention for producing a microorganism biomass comprises the steps of cultivating viable cells of the microorganism in an aqueous nutrient containing medium at a physiological pH, and adding to the culture an amount of a high-intensity sweetener, and in some embodiments, adding an amount of a high intensity sweetener which results in an oxidative stability index greater than the oxidative stability index of the culture in the absence of the high-intensity sweetener.

The invention provides also a microbial biomass which comprises viable cells of the microorganism and a high-intensity sweetener.

The high-intensity sweetener may be added at any time during the culturing process; that is, prior to the addition of the microorganism, during the culturing of the microorganism, or at the end of the culturing. The high-intensity sweetener can be added in a single addition, or multiple times throughout the culturing.

In other embodiments, the high-intensity sweetener may be added after the culturing of the microorganisms, for example, during harvest of the microorganisms, or post-harvest processing.

The present invention further includes a method of making a dried culture of cells of a microorganism which comprises the steps of: cultivating viable cells of the microorganism in an aqueous nutrient containing medium at a physiological pH; concentrating the culture to a cell concentration of at least 20% w/w; adding to the concentrated culture amounts of a high-intensity sweetener and drying the sweetened culture. Cultures may be concentrated by any suitable means, for example by centrifugation or by ultrafiltration in order to reach the cell concentration desired. After concentration, the high-intensity sweetener may be added to the concentrated culture in any suitable manner and may be mixed into the culture by any suitable means in order to achieve a satisfactory degree of dispersion throughout it.

Dry cultures of microorganisms have a wide range of applications, including use in silage, hay and grain additives, dressings, or as probiotics. In some embodiments, the dried cultures of the invention are suitable for use as dry stable cultures with high viabilities, for example viabilities of the order of 10¹¹ colony forming units per gram.

The mass fractions of the high-intensity sweetener in a dry culture of microorganisms is preferably in the ranges of 0.05 to 0.3, and in some embodiments, 0.25 to 0.3.

The high-intensity sweetener can be selected from, for example, sucralose, saccharine, cyclamates, aspartame, neotame, acesulfame potassium (potassium salt of 6-methyl-1,2,3-oxathiazine-4(3H)-one 2,2-dioxide; white crystalline powder with molecular formula of C₄H₄NO₄KS and molecular weight of 201.24), alitame, thaumatin, dihydrochalcone, stevioside, glycyrrhizin, monellin, and salts of the foregoing and mixtures thereof. In preferred embodiments, the high-intensity sweetener is selected from high-intensity sweeteners that contain a nitrogen moiety, such as ones that are amino acid-based sweeteners (such as dipeptide or tripeptide sweeteners). Reference to high intensity sweeteners includes chemically modified versions of the same. More particularly, preferred high-intensity sweeteners of the present invention include aspartame, neotame, acesulfame potassium, and alitame. More particularly, preferred high-intensity sweeteners of the present invention include aspartame, neotame, and alitame.

In preferred embodiments, the high-intensity sweetener can be non-hydrated. Reference to the high-intensity sweetener being non-hydrated typically refers to the sweetener being in the form of an anhydrous powder. It will be recognized that in ambient environments, some amounts of moisture become introduced to an anhydrous material. Therefore, it should be recognized that reference to a non-hydrated sweetener means that the sweetener has not been actively hydrated such as to aid in introduction of the sweetener into oil or the stabilization of the sweetener in oil. In some embodiments, the non-hydrated high-intensity sweetener comprises less than about 5%, and preferably less than about 2%, by weight water before combination with the oil.

The amount of high-intensity sweetener present in a sweetened oil composition of the present invention is sufficient to noticeably sweeten the oil composition. Such an amount can vary depending on the degree of solubility of a particular high-intensity sweetener in a particular oil. More particularly, the amount of sweetener in an oil composition of the present invention can vary in an amount between about 0.01% by weight and about 3% by weight, about 0.02% by weight and about 2% by weight, and between about 0.1% by weight and about 1.5% by weight. While the solubility of the high-intensity sweeteners in the oil is partial, it has been found that this level of solubility is sufficient to impart a sweetness to the oil, in part due to the high-intensity sweeteners being sweeter than typical table sugar (sucrose). It has been found, however, that neotame has some significant solubility in oil.

The sweetened oil composition also comprises an oil with at least one LC-PUFA. In some embodiments, the LC-PUFA has at least three double bonds. In some embodiments, the oil comprising at least one LC-PUFA at least comprises a LC-PUFA selected from the group consisting of docosahexaenoic acid, docosapentaenoic acid, arachidonic acid, and eicosapentaenoic acid. In some embodiments, the oil comprising at least one LC-PUFA is selected from the group consisting of a microbial oil, a plant seed oil, and an aquatic animal oil. Examples of LC-PUFAs are docosahexaenoic acid C22:6(n-3) (DHA), omega-3 docosapentaenoic acid C22:5(n-3) (DPA), omega-6 docosapentaenoic acid C22:5(n-6) (DPA), arachidonic acid C20:4(n-6) (ARA), eicosapentaenoicacid C20:5(n-3) (EPA), stearidonic acid, linolenic acid, alpha linolenic acid (ALA), gamma linolenic acid (GLA), conjugated linolenic acid (CLA) or mixtures thereof. The PUFAs preferably can be in any of the common forms found in natural lipids including but not limited to triacylglycerols, diacylglycerols, phospholipids, free fatty acids, esterified fatty acids, or in natural or synthetic derivative forms of these fatty acids (e.g. calcium salts of fatty acids, ethyl esters, etc). Reference to an oil comprising an LC-PUFA, as used in the present invention, can refer to either an oil comprising only a single LC-PUFA such as DHA or an oil comprising a mixture of two or more LC-PUFAs such as DHA and EPA, or DHA and ARA.

A preferred source of an oil comprising at least one LC-PUFA, in the compositions and methods of the present invention, includes a microbial source. Microbial sources and methods for growing microorganisms comprising nutrients and/or LC-PUFAs are known in the art (Industrial Microbiology and Biotechnology, 2^{nd} edition, 1999, American Society for Microbiology). Preferably, the microorganisms are cultured in a fermentation medium in a fermentor. The methods and compositions of the present invention are applicable to any industrial microorganism that produces any kind of nutrient or desired component such as, for example algae, protists, bacteria and fungi (including yeast).

Microbial sources can include a microorganism such as an algae, bacteria, fungi and/or protist. Preferred organisms include those selected from the group consisting of golden algae (such as microorganisms of the kingdom Stramenopiles), green algae, diatoms, dinoflagellates (such as microorganisms of the order Dinophyceae including members of the genus Crypthecodinium such as, for example, Crypthecodinium cohnii), yeast, and fungi of the genera Mucor and Mortierella, including but not limited to Mortierella alpina and Mortierella sect. schmuckeri. Members of the microbial group Stramenopiles include microalgae and algae-like microorganisms, including the following groups of microorganisms: Hamatores, Proteromonads, Opalines, Develpayella, Diplophrys, Labrinthulids, Thraustochytrids, Biosecids, Oomycetes, Hypochytridiomycetes, Commation, Reticulosphaera, Pelagomonas, Pelagococcus, Ollicola, Aureococcus, Parmales, Diatoms, Xanthophytes, Phaeophytes (brown algae), Eustigmatophytes, Raphidophytes, Synurids, Axodines (including Rhizochromulinaales, Pedinellales, Dictyochales), Chrysomeridales, Sarcinochrysidales, Hydrurales, Hibberdiales, and Chromulinales. The Thraustochytrids include the genera Schizochytrium (species include aggregatum, limnaceum, mangrovei, minutum, octosporum), Thraustochytrium (species include arudimentale, aureum, benthicola, globosum, kinnei, motivum, multirudimentale, pachydermum, proliferum, roseum, striatum), Ulkenia* (species include amoeboidea, kerguelensis, minuta, profunda, radiate, sailens, sarkariana, schizochytrops, visurgensis, yorkensis), Aplanochytrium (species include haliotidis, kerguelensis, profunda, stocchinoi), Japonochytrium (species include marinum), Althornia (species include crouchii), and Elina (species include marisalba, sinorifica). The Labrinthulids include the genera Labyrinthula (species include algeriensis, coenocystis, chattonii, macrocystis, macrocystis atlantica, macrocystis macrocystis, marina, minuta, roscoffensis, valkanovii, vitellina, vitellina pacifica, vitellina vitellina, zopfi), Labyrinthomyxa (species include marina), Labyrinthuloides (species include haliotidis, yorkensis), Diplophrys (species include archeri), Pyrrhosorus* (species include marinus), Sorodiplophrys* (species include stercorea), Chlamydomyxa* (species include labyrinthuloides, montana). (*=there is no current general consensus on the exact taxonomic placement of these genera).

While processes of the present invention can be used to produce forms of LC-PUFAs that can be produced in a wide variety of microorganisms, for the sake of brevity, convenience and illustration, this detailed description of the invention will discuss processes for growing microorganisms which are capable of producing lipids comprising omega-3 and/or omega-6 polyunsaturated fatty acids, in particular microorganisms that are capable of producing DHA (or closely related compounds such as DPA, EPA or ARA). Additional preferred microorganisms are algae, such as Thraustochytrids of the order Thraustochytriales, including Thraustochytrium (including Ulkenia), and Schizochytrium, and including Thraustochytriales which are disclosed in commonly assigned U.S. Pat. Nos. 5,340,594 and 5,340,742, both issued to Barclay, all of which are incorporated herein by reference in their entirety. More preferably, the microorganisms are selected from the group consisting of microorganisms having the identifying characteristics of ATCC number 20888, ATCC number 20889, ATCC number 20890, ATCC number 20891 and ATCC number 20892. Since there is some disagreement among experts as to whether Ulkenia is a separate genus from the genus Thraustochytrium, for the purposes of this application, the genus Thraustochytrium will include Ulkenia. Also preferred are strains of Mortierella schmuckeri (e.g., including microorganisms having the identifying characteristics of ATCC 74371) and Mortierella alpina. (e.g., including microorganisms having the identifying characteristics of ATCC 42430). Also preferred are strains of Crypthecodinium cohnii, including microorganisms having the identifying characteristics of ATCC Nos. 30021, 30334-30348, 30541-30543, 30555-30557, 30571, 30572, 30772-30775, 30812, 40750, 50050-50060, and 50297-50300. Also preferred are mutant strains derived from any of the foregoing, and mixtures thereof. Oleaginous microorganisms are also preferred. As used herein, “oleaginous microorganisms” are defined as microorganisms capable of accumulating greater than 20% of the weight of their cells in the form of lipids. Genetically modified microorganisms that produce LC-PUFAs are also suitable for the present invention. These can include naturally LC-PUFA-producing microorganisms that have been genetically modified as well as microorganisms that do not naturally produce LC-PUFAs but that have been genetically modified to do so.

Suitable organisms may be obtained from a number of available sources, including by collection from the natural environment. For example, the American Type Culture Collection currently lists many publicly available strains of microorganisms identified above. As used herein, any organism, or any specific type of organism, includes wild strains, mutants, or recombinant types. Growth conditions in which to culture or grow these organisms are known in the art, and appropriate growth conditions for at least some of these organisms are disclosed in, for example, U.S. Pat. No. 5,130,242, U.S. Pat. No. 5,407,957, U.S. Pat. No. 5,397,591, U.S. Pat. No. 5,492,938, and U.S. Pat. No. 5,711,983, all of which are incorporated herein by reference in their entirety.

Another preferred source of an oil comprising at least one LC-PUFA, in the compositions and methods of the present invention includes a plant source, such as oilseed plants. Since plants do not naturally produce LC-PUFAs having carbon chains of 20 or greater, plants producing such LC-PUFAs are those genetically engineered to express genes that produce such LC-PUFAs. Thus, in some embodiments, the oil comprising at least one LC-PUFA is a plant seed oil derived from an oil seed plant that has been genetically modified to produce long chain polyunsaturated fatty acids. Such genes can include genes encoding proteins involved in the classical fatty acid synthase pathways, or genes encoding proteins involved in the PUFA polyketide synthase (PKS) pathway. The genes and proteins involved in the classical fatty acid synthase pathways, and genetically modified organisms, such as plants, transformed with such genes, are described, for example, in Napier and Sayanova, Proceedings of the Nutrition Society (2005), 64:387-393; Robert et al., Functional Plant Biology (2005) 32:473-479; or U.S. Patent Application Publication 2004/0172682. The PUFA PKS pathway, genes and proteins included in this pathway, and genetically modified microorganisms and plants transformed with such genes for the expression and production of PUFAs are described in detail in: U.S. Pat. No. 6,566,583; U.S. Patent Application Publication No. 20020194641, U.S. Patent Application Publication No. 20040235127A1, and U.S. Patent Application Publication No. 20050100995A1, each of which is incorporated herein by reference in its entirety.

Preferred oilseed crops include soybeans, corn, safflower, sunflower, canola, flax, peanut, mustard, rapeseed, chickpea, cotton, lentil, white clover, olive, palm oil, borage, evening primrose, linseed, and tobacco that have been genetically modified to produce LC-PUFA as described above.

Genetic transformation techniques for microorganisms and plants are well-known in the art. Transformation techniques for microorganisms are well known in the art and are discussed, for example, in Sambrook et al., 1989, Molecular Cloning: A Laboratory Manual, Cold Spring Harbor Labs Press. A general technique for transformation of dinoflagellates, which can be adapted for use with Crypthecodinium cohnii, is described in detail in Lohuis and Miller, The Plant Journal (1998) 13(3): 427-435. A general technique for genetic transformation of Thraustochytrids is described in detail in U.S. Patent Application Publication No. 20030166207, published Sep. 4, 2003. Methods for the genetic engineering of plants are also well known in the art. For instance, numerous methods for plant transformation have been developed, including biological and physical transformation protocols. See, for example, Miki et al., “Procedures for Introducing Foreign DNA into Plants” in Methods in Plant Molecular Biology and Biotechnology, Glick, B. R. and Thompson, J. E. Eds. (CRC Press, Inc., Boca Raton, 1993) pp. 67-88. In addition, vectors and in vitro culture methods for plant cell or tissue transformation and regeneration of plants are available. See, for example, Gruber et al., “Vectors for Plant Transformation” in Methods in Plant Molecular Biology and Biotechnology, Glick, B. R. and Thompson, J. E. Eds. (CRC Press, Inc., Boca Raton, 1993) pp. 89-119. See also, Horsch et al., Science 227:1229 (1985); Kado, C. I., Crit. Rev. Plant. Sci. 10:1 (1991); Moloney et al., Plant Cell Reports 8:238 (1989); U.S. Pat. No. 4,940,838; U.S. Pat. No. 5,464,763; Sanford et al., Part. Sci. Technol. 5:27 (1987); Sanford, J. C., Trends Biotech. 6:299 (1988); Sanford, J. C., Physiol. Plant 79:206 (1990); Klein et al., Biotechnology 10:268 (1992); Zhang et al., Bio/Technology 9:996 (1991); Deshayes et al., EMBO J., 4:2731 (1985); Christou et al., Proc Natl. Acad. Sci. USA 84:3962 (1987); Hain et al., Mol. Gen. Genet. 199:161 (1985); Draper et al., Plant Cell Physiol. 23:451 (1982); Donn et al., In Abstracts of VIth International Congress on Plant Cell and Tissue Culture IAPTC, A2-38, p. 53 (1990); D'Halluin et al., Plant Cell 4:1495-1505 (1992) and Spencer et al., Plant Mol. Biol. 24:51-61 (1994).

When oilseed plants are the source of LC-PUFAs, the seeds can be harvested and processed to remove any impurities, debris or indigestible portions from the harvested seeds prior to subjecting them to a step of hydrolyzing. Processing steps vary depending on the type of oilseed and are known in the art. Processing steps can include threshing (such as, for example, when soybean seeds are separated from the pods), dehulling (removing the dry outer covering, or husk, of a fruit, seed, or nut), drying, cleaning, grinding, milling and flaking. After the seeds have been processed to remove any impurities, debris or indigestible materials, they can be added to an aqueous solution preferably, water and then mixed to produce a slurry. Preferably, milling, crushing or flaking is performed prior to mixing with water. A slurry produced in this manner can be treated and processed the same way as described for a microbial fermentation broth. Size reduction, heat treatment, pH adjustment, pasteurization and other known treatments can be used in order to improve hydrolysis, emulsion preparation, and quality (nutritional and sensory).

Another preferred source of an oil comprising at least one LC-PUFA, in the compositions and methods of the present invention includes an animal source. Thus, in some embodiments, the oil comprising at least one LC-PUFA is an aquatic animal oil. Examples of animal sources include aquatic animals (e.g., fish, marine mammals, and crustaceans such as krill and other euphausids) and lipids extracted from animal tissues (e.g., brain, liver, eyes, etc.) and animal products such as eggs or milk.

It has been found that, in preferred embodiments, the sweetened oil composition of the present invention is one in which the oil comprising at least one LC-PUFA is more oxidatively stable with the high-intensity sweetener than without it. More particularly, the sweetened oil composition has an oxidative stability index greater than the oxidative stability index of the same oil comprising at least one LC-PUFA without the high-intensity sweetener.

The oxidative state and stability of a composition including a lipid can be measured in a number of ways known in the art, and descriptions of many of these techniques are available from the American Oil Chemist's Society, as well as from other sources. One method of quantifying the oxidative stability of a product is by measuring the Oxidative Stability Index (OSI), such as by use of a Rancimat instrument, which measures the amount of conductive species (volatile decomposition products) that are evolved from a sample as it is subjected to thermal decomposition.

In some embodiments, the sweetened oil composition has an oxidative stability index of at least about 5% greater than the oxidative stability index of the same oil comprising at least one LC-PUFA without the high-intensity sweetener, at least about 10% greater than the oxidative stability index of the same oil comprising at least one LC-PUFA without the high-intensity sweetener, at least about 15% greater than the oxidative stability index of the same oil comprising at least one LC-PUFA without the high-intensity sweetener, at least about 20% greater than the oxidative stability index of the same oil comprising at least one LC-PUFA without the high-intensity sweetener, at least about 30% greater than the oxidative stability index of the same oil comprising at least one LC-PUFA without the high-intensity sweetener, at least about 50% greater than the oxidative stability index of the same oil comprising at least one LC-PUFA without the high-intensity sweetener, at least about 100% greater than the oxidative stability index of the same oil comprising at least one LC-PUFA without the high-intensity sweetener, or at least about 200% greater than the oxidative stability index of the same oil comprising at least one LC-PUFA without the high-intensity sweetener.

In preferred embodiments in which the high-intensity sweetener increases the oxidative stability of the composition, the high-intensity sweetener is selected from high-intensity sweeteners that are amino acid based sweeteners, and more particularly, those that are dipeptide or tripeptide based compounds. In particularly preferred embodiments, such high-intensity sweeteners are selected from aspartame, neotame and alitame.

In some embodiments, the sweetened oil composition further comprises at least one additional component. While the present invention provides a sweetened oil composition that does not contain stabilizing agents, additional components can be provided in the composition. Such additional components can include, for example, antioxidants, flavors, flavor enhancers, pigments, vitamins, minerals, prebiotic compounds, and combinations thereof.

Suitable antioxidants can be, for example, vitamin E, butylhydroxytoluene (BHT), butylhydroxyanisole (BHA), tert-butylhydroquinone (TBHQ), propyl gallate (PG), vitamin C, a phospholipid, or a natural antioxidant, and in a preferred embodiment is TBHQ. The antioxidant preferably can be present in an amount of between about 0.01% and about 0.2% by weight of the oil or between about 0.05% and about 0.15% by weight of the oil. A wide variety of flavors can be added based on the flavor desired for a specific application. For example, an oil could be sweetened and vanilla flavored for use in baked products or in beverages. Many other combinations are possible. A sampling of possible flavors includes, for example, nut, amaretto, anisette, brandy, cappuccino, mint, cinnamon, cinnamon almond, creme de menthe, Grand Mariner, peppermint stick, pistachio, sambuca, apple, chamomile, cinnamon spice, creme, vanilla, French vanilla, Irish creme, Kahlua, mint, lemon, macadamia nut, orange, orange leaf, peach, strawberry, grape, raspberry, cherry, coffee, chocolate, cocoa, mocha and the like, and mixtures thereof.

Examples of taste and/or flavor enhancers are the following: agents influencing saltiness (e.g., halides of group IA elements), sourness (e.g., protonic organic acids), bitterness (e.g., alkaloids, terpenes, flavonoids, amino acids, peptides) and taste modifiers (e.g., gymnemic acid, taste-modifying proteins which change the taste from sour to sweet, and chlorogenic acid, cynarin). Still other examples comprise menthol and piperine and similar compounds which cause specific taste sensations.

Suitable pigments can be, for example, natural or artificial dyes that include FD&C dyes (food, drug and cosmetic use dyes) of blue, green, orange, red, yellow and violet; iron oxide dyes; ultramarine pigments of blue, pink, red and violet; and equivalents thereof.

Suitable vitamins, can be, for example, Vitamin A, Vitamin D, Vitamin E, Vitamin K, Vitamin B1, Vitamin B2, Vitamin B3, Vitamin B6, Vitamin C, Folic Acid, Vitamin B-12, Biotin, Vitamin B5 or mixtures thereof.

Suitable minerals, can be, for example, calcium, iron, iodine, magnesium, zinc, selenium, copper, manganese, chromium, molybdenum or mixtures thereof.

Prebiotic compounds are a non-digestible food ingredient that beneficially affects the host by selectively stimulating the growth and/or the activity of one or a limited number of bacteria in the colon. Prebiotics are typically thought of as carbohydrates of relatively short chain length. Examples of prebiotic nondigestble carbohydrates are inulin, oligofructose and lactulose.

A further embodiment of the present invention is an encapsulated product comprising a sweetened oil composition of the present invention that has been encapsulated.

Encapsulation of compositions of the present invention can be by any method known in the art. For example, the composition can be spray-dried. Other methods for encapsulation are known, such as fluid bed drying, drum (film) drying, coacervation, interfacial polymerization, fluid bed processing, pan coating, spray gelation, ribbon blending, spinning disk, centrifugal coextrusion, inclusion complexation, emulsion stabilization, spray coating, extrusion, liposome nanoencapsulation, supercritical fluid microencapsulation, suspension polymerization, cold dehydration processes, spray cooling/chilling (prilling), evaporative dispersion processes, and methods that take advantage of differential solubility of coatings at varying temperatures.

Some exemplary encapsulation techniques are summarized below. It should be recognized that reference to the various techniques summarized below includes the description herein and variations of those descriptions known to those in the art.

In spray drying, the material to be encapsulated is dispersed or dissolved in a solution. Typically, the solution is aqueous and the solution includes a polymer. The solution or dispersion is pumped through a micronizing nozzle driven by a flow of compressed gas, and the resulting aerosol is suspended in a heated cyclone of air, allowing the solvent to evaporate from the microdroplets. The solidified microparticles pass into a second chamber and are trapped in a collection flask.

Interfacial polycondensation is used to encapsulate a material in the following manner. One monomer and the material are dissolved in a solvent. A second monomer is dissolved in a second solvent (typically aqueous) which is immiscible with the first. An emulsion is formed by suspending the first solution in the second solution by stirring. Once the emulsion is stabilized, an initiator is added to the aqueous phase causing interfacial polymerization at the interface of each droplet of emulsion.

In hot melt encapsulation the material is added to molten polymer. This mixture is suspended as molten droplets in a nonsolvent for the polymer (often oil-based) which has been heated to approximately 10° C. above the melting point of the polymer. The emulsion is maintained through vigorous stirring while the nonsolvent bath is quickly cooled below the glass transition of the polymer, causing the molten droplets to solidify and entrap the core material.

In solvent evaporation encapsulation, a polymer is typically dissolved in a water immiscible organic solvent and the material to be encapsulated is added to the polymer solution as a suspension or solution in organic solvent. An emulsion is formed by adding this suspension or solution to a vessel of vigorously stirred water (often containing a surface active agent to stabilize the emulsion). The organic solvent is evaporated while continuing to stir. Evaporation results in precipitation of the polymer, forming solid microcapsules containing core material.

The solvent evaporation process is designed to entrap a liquid material in a polymer, copolymer, or copolymer microcapsules. The polymer or copolymer is dissolved in a miscible mixture of solvent and nonsolvent, at a nonsolvent concentration which is immediately below the concentration which would produce phase separation (i.e., cloud point). The liquid material is added to the solution while agitating to form an emulsion and disperse the material as droplets. Solvent and nonsolvent are vaporized, with the solvent being vaporized at a faster rate, causing the polymer or copolymer to phase separate and migrate towards the surface of the material droplets. This phase separated solution is then transferred into an agitated volume of nonsolvent, causing any remaining dissolved polymer or copolymer to precipitate and extracting any residual solvent from the formed membrane. The result is a microcapsule composed of polymer or copolymer shell with a core of liquid material.

In solvent removal encapsulation, a polymer is typically dissolved in an oil miscible organic solvent and the material to be encapsulated is added to the polymer solution as a suspension or solution in organic solvent. An emulsion is formed by adding this suspension or solution to a vessel of vigorously stirring oil, in which the oil is a nonsolvent for the polymer and the polymer/solvent solution is immiscible in the oil. The organic solvent is removed by diffusion into the oil phase while continuing to stir. Solvent removal results in precipitation of the polymer, forming solid microcapsules containing core material.

In phase separation encapsulation, the material to be encapsulated is dispersed in a polymer solution by stirring. While continuing to uniformly suspend the material through stirring, a nonsolvent for the polymer is slowly added to the solution to decrease the polymer's solubility. Depending on the solubility of the polymer in the solvent and nonsolvent, the polymer either precipitates or phase separates into a polymer rich and a polymer poor phase. Under proper conditions, the polymer in the polymer rich phase will migrate to the interface with the continuous phase, encapsulating the core material in a droplet with an outer polymer shell.

Spontaneous emulsification involves solidifying emulsified liquid polymer droplets by changing temperature, evaporating solvent, or adding chemical cross-linking agents. Physical and chemical properties of the encapsulant and the material to be encapsulated dictate suitable methods of encapsulation. Factors such as hydrophobicity, molecular weight, chemical stability, and thermal stability affect encapsulation.

Coacervation is a process involving separation of colloidal solutions into two or more immiscible liquid layers (Dowben, R. General Physiology, Harper & Row, New York, 1969, pp. 142-143). Through the process of coacervation, compositions comprised of two or more phases and known as coacervates may be produced. The ingredients that comprise the two phase coacervate system are present in both phases; however, the colloid-rich phase has a greater concentration of the components than the colloid-poor phase.

Low temperature microsphere formation has been described, see, e.g., U.S. Pat. No. 5,019,400. The method is a process for preparing microspheres which involves the use of very cold temperatures to freeze polymer-biologically active agent mixtures into polymeric microspheres. The polymer is generally dissolved in a solvent together with an active agent that can be either dissolved in the solvent or dispersed in the solvent in the form of microparticles. The polymer/active agent mixture is atomized into a vessel containing a liquid non-solvent, alone or frozen and overlayed with a liquefied gas, at a temperature below the freezing point of the polymer/active agent solution. The cold liquefied gas or liquid immediately freezes the polymer droplets. As the droplets and non-solvent for the polymer is warmed, the solvent in the droplets thaws and is extracted into the non-solvent, resulting in hardened microspheres.

Phase separation encapsulation generally proceeds more rapidly than the procedures described in the preceding paragraphs. A polymer is dissolved in the solvent. An agent to be encapsulated then is dissolved or dispersed in that solvent. The mixture then is combined with an excess of nonsolvent and is emulsified and stabilized, whereby the polymer solvent no longer is the continuous phase. Aggressive emulsification conditions are applied in order to produce microdroplets of the polymer solvent. After emulsification, the stable emulsion is introduced into a large volume of nonsolvent to extract the polymer solvent and form microparticles. The size of the microparticles is determined by the size of the microdroplets of polymer solvent.

Another method for encapsulating is by phase inversion nanoencapsulation (PIN). In PIN, a polymer is dissolved in an effective amount of a solvent. The agent to be encapsulated is also dissolved or dispersed in the effective amount of the solvent. The polymer, the agent and the solvent together form a mixture having a continuous phase, wherein the solvent is the continuous phase. The mixture is introduced into an effective amount of a nonsolvent to cause the spontaneous formation of the microencapsulated product, wherein the solvent and the nonsolvent are miscible.

In preparing an encapsulated product of the present invention, the conditions can be controlled by one skilled in the art to yield encapsulated material with the desired attributes. For example, the average particle size, hydrophobicity, biocompatibility, ratio of material to encapsulant, thermal stability, and the like can be varied by one skilled in the art. Encapsulated products of the present invention, in addition to increased stability from the use of specific high-intensity sweeteners, as described herein, are particularly stable, because of the encapsulant.

The present invention also provides a product comprising the sweetened oil compositions and encapsulated sweetened oil compositions as previously described. In various embodiments, the product is selected from the group consisting of a food product, a nutritional product and a medical product.

Liquid food and nutritional products include, for example, beverages, energy drinks, infant formula, liquid meals, fruit juices, liquid eggs, milk, milk products, and multivitamin syrups. Solid food and nutritional products include, for example, baby food, yoghurt, cheese, cereal, powdered mixes, baked goods, food bars, and processed meats. Baked goods include such foods as cookies, crackers, sweet goods, muffins, cereals, snack cakes, pies, granola/snack bars, and toaster pastries. Other foods include salted snacks such as potato chips, corn chips, wheat chips, sorghum chips, soy chips, tortilla chips, extruded snacks, popcorn (including microwaveable popcorn), pretzels, potato crisps, and nuts; specialty snacks such as dried fruit snacks, meat snacks, pork rinds, health food bars, rice cakes and corn cakes; confectionary snacks such as candy; and naturally occurring snack foods such as nuts, dried fruits and vegetables.

Medical products include medical foods. A medical food includes a food which is in a formulation to be consumed or administered externally under the supervision of a physician and which is intended for the specific dietary management of a disease or condition for which distinctive nutritional requirements, based on recognized scientific principles, are established by medical evaluation. In some embodiments, the medical product is a solid or liquid pharmaceutical composition. The sweetened oil compositions may be combined with an effective amount of a pharmaceutical agent in a finished composition.

The present invention also provides a method for producing a sweetened oil composition comprising contacting an oil comprising at least one LC-PUFA with a high-intensity sweetener in the absence of stabilizing agents to form the sweetened oil composition. High-intensity sweeteners and LC-PUFAs have been described above.

The method relies on the partial solubility of high-intensity sweeteners in the oils. While the solubility of the high-intensity sweeteners is partial, it has been found that this level of solubility is generally sufficient to impart a sweetness to the oil, in part due to the high-intensity sweeteners being sweeter, and in some instances, many times sweeter, than typical table sugar (sucrose). In some embodiments of the method, an amount of high-intensity sweetener is contacted with the oil, the amount being in excess of the amount that will solubilize in the oil. Once the sweetener has been allowed to solubilize in the oil, the excess high-intensity sweetener can be separated from the resulting sweetened oil composition. The excess of the high-intensity sweetener is contacted with the oil for a time sufficient to allow the sweetener to dissolve in the oil. Preferably, the time of contacting is at least about five minutes to at least about 15 minutes before the step of separating is conducted.

The excess sweetener may be separated from the sweetened oil composition by any suitable method known in the art, such as decanting, centrifuging, and filtering.

In other embodiments, a higher intensity of sweetening may be achieved by allowing some of the sweetener to be left suspended in the oil. It should be noted that only small amounts of suspended sweetener are needed to impart a higher sweetness intensity.

In some embodiments of the method, the step of contacting comprises passing the oil comprising at least one LC-PUFA over a column comprising the high-intensity sweetener and recovering sweetened oil composition from the column. In this embodiment, the sweetener is transferred to the oil by mass transfer. The sweetness intensity will be self-regulating, since the amount of sweetener that will dissolve in the oil is determined by the solubility of the sweetener in the oil.

In some embodiments of the method, the step of contacting is conducted at about room temperature (i.e., about 20 C). Contacting at room temperature will avoid supersaturation that will occur at high temperatures. In other embodiments however, the step of contacting is conducted at a temperature above room temperature, including, in some embodiments, a temperature of between about 35° C. and about 55° C. In other embodiments of the method, the step of contacting is conducted at a temperature below about 60° C. Conducting the contacting step at a temperature above room temperature will be beneficial in promoting solubility in certain embodiments, such as the embodiment in which the oil is passed over a column of sweetener.

In some embodiments of the method, the step of contacting comprises agitating the oil comprising at least one LC-PUFA and high-intensity sweetener. The agitation will be sufficient to create a dispersion of sweetener particles within the oil, while avoiding the creation of vortices or introduction of air into the oil. In some embodiments, the agitation is performed in a non-oxidizing environment, such as in the case of an application of a nitrogen blanket.

In some embodiments of the method, the method further comprises adding at least one additional component to the composition comprising the oil comprising at least one LC-PUFA and the high-intensity sweetener. Additional components, including, antioxidants, flavors, flavor enhancers, pigments, vitamins, minerals, prebiotic compounds, and combinations thereof, are described above. The step of adding can include mixing the additional component to the combination of the oil comprising at least one LC-PUFA and the high-intensity sweetener, or mixing the additional component with either the oil comprising at least one LC-PUFA or the high-intensity sweetener before combination thereof.

In a preferred embodiment, the sweetened oils of present invention can be prepared by utilizing micronized high-intensity sweeteners. Micronization is the process by which solid particles are reduced in size to small particle sizes. It is believed that micronization increases the dissolution rate of relatively lipid-insoluble sweeteners. Without being bound by theory, it is believed that since the dissolution rate is dependent on the surface area of the solid, and reducing the particle size increases the surface area, reducing the particle size increases the dissolution rate. Additionally, it is believed that sweetened oils comprising micronized sweeteners may form stable suspensions which do not have a cloudy appearance. In some embodiments, the micronized sweeteners utilized in the present invention have an average particle size less than about 50 μm, in some embodiments less than about 25 μm, in some embodiments less than about 15 μm, in some embodiments less than about 10 μm, in some embodiments less than about 5 μm, in some embodiments less than about 1 μm, in some embodiments less than about 0.75 μm, in some embodiments less than about 0.5 μm, in some embodiments less than about 0.25 μm, in some embodiments less than about 0.1 μm.

In a related embodiment, the invention provides a method for producing a sweetened oil composition comprising contacting an oil comprising at least one LC-PUFA with a micronized high-intensity sweetener in the absence of stabilizing agents to form the sweetened oil composition. The high-intensity sweetener can be non-hydrated. In some embodiments, the method further comprises micronizing the sweetener prior to contacting it with the oil comprising at least one LC-PUFA.

Additional objects, advantages, and novel features of this invention will become apparent to those skilled in the art upon examination of the following examples thereof, which are not intended to be limiting.

### EXAMPLES

### Example 1

This example shows the preparation of sweetened oil compositions of the present invention.

Martek DHA™-S algal oil (Martek Biosciences Corporation, Columbia, Md.) was combined at room temperature with each of aspartame, acesulfame potassium, sucralose, and neotame to form a sweetened oil composition. Each of the oils was taste tested for sweetness and all of the compositions had a sweet flavor.

### Example 2

This example evaluates the various sweetened oil compositions of Example 1 for oxidative stability.

The sweetened oil samples were evaluated on an oxidation stability index, or OSI. The samples were held at 80° C. and with air bubbled through the samples until the sensors in the instrument determine the induction point when the oil oxidizes.

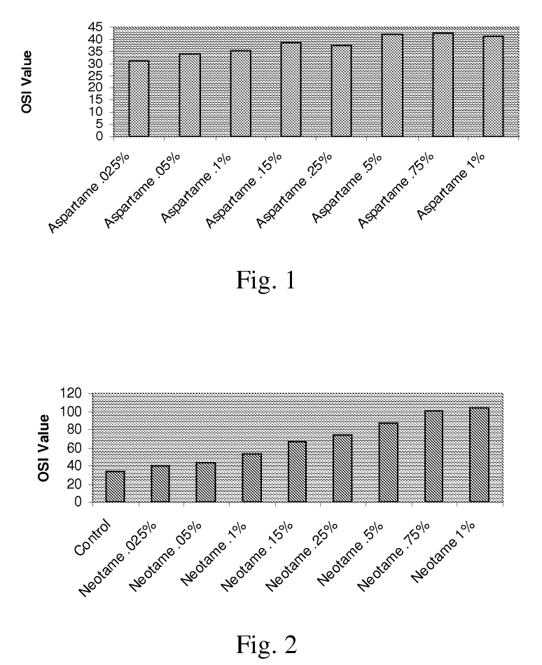

The results show that aspartame increases the oxidative stability of Martek DHA™-S algal oil, acesulfame potassium has no effect, sucralose decreases stability and neotame greatly increases the oxidative stability when fortified at certain amounts. The optimal level for aspartame was 0.75% at which the oxidation resistance increased 17.2% compared to the control (FIG. 1). The samples fortified with neotame at 0.75% and 1% increased the oxidation resistance of the oil by 200% (FIG. 2 and Table 1)

TABLE 1
OSI increases with increasing percent neotame in algal oil

| | | Percent increase from |
|---|---|---|
| Neotame (%) | OSI | control |
| 0 (Control) | 34.05 | 0 |
| 0.025% | 40.2 | 18.1 |
| 0.05% | 44.23 | 29.9 |
| 0.1% | 53.425 | 56.9 |
| 0.15% | 66.125 | 94.2 |
| 0.25% | 73.95 | 117.2 |
| 0.5% | 86.85 | 155.1 |
| 0.75% | 101.125 | 197 |
| 01% | 104.76 | 207.7 |

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A sweetened oil composition, comprising:
a. an oil comprising at least one LC-PUFA, and
b. a non-hydrated high-intensity sweetener,
wherein the oil composition does not contain stabilizing agents.

2. The sweetened oil composition of claim 1, wherein the high-intensity sweetener comprises a high-intensity sweetener selected from the group consisting of sucralose, saccharine, cyclamates, aspartame, neotame, acesulfame potassium, alitame, thaumatin, dihydrochalcone, stevioside, glycyrrhizin, monellin, salts of the foregoing and mixtures thereof.

3. The sweetened oil composition of claim 1, wherein the high-intensity sweetener comprises an amino acid based sweetener.

4. The sweetened oil composition of claim 1, wherein the high-intensity sweetener is selected from the group consisting of aspartame, neotame, and alitame.

5. The sweetened oil composition of claim 1, wherein the high-intensity sweetener comprises neotame.

6. The sweetened oil composition of claim 1, wherein the high-intensity sweetener comprises aspartame.

7. The sweetened oil composition of claim 1, wherein the high-intensity sweetener is present in amounts between about 0.01% by weight and about 3% by weight.

8. The sweetened oil composition of claim 1, wherein the high-intensity sweetener is present in amounts between about 0.1% by weight and about 1.5% by weight.

9. The sweetened oil composition of claim 1, wherein the sweetened oil composition has an oxidative stability index greater than the oxidative stability index of the oil comprising at least one LC-PUFA.

10. The sweetened oil composition of claim 1, wherein the sweetened oil composition has an oxidative stability index of at least about 5% greater than the oxidative stability index of the oil comprising at least one LC-PUFA.

11. (canceled)

12. (canceled)

13. (canceled)

14. (canceled)

15. (canceled)

16. (canceled)

17. (canceled)

18. The sweetened oil composition of claim 1, wherein the high-intensity sweetener comprises less than about 5% by weight water before combination with the oil.

19. The sweetened oil composition of claim 1, wherein the LC-PUFA has a carbon chain length of at least 20.

20. The sweetened oil composition of claim 1, wherein the LC-PUFA has at least three double bonds.

21. The sweetened oil composition of claim 1, wherein the oil comprising at least one LC-PUFA at least comprises a LC-PUFA selected from the group consisting of docosahexaenoic acid, eicosapentaenoic acid, omega-3 docosapentaenoic acid, omega-6 docosapentaenoic acid, arachidonic acid, stearidonic acid, linolenic acid, alpha linolenic acid, gamma linolenic acid, conjugated linolenic acid, and mixtures thereof.

22. The sweetened oil composition of claim 1, wherein the oil comprising at least one LC-PUFA is selected from the group consisting of a microbial oil, a plant seed oil, and an aquatic animal oil.

23. The sweetened oil composition of claim 1, wherein the oil comprising at least one LC-PUFA is a microbial oil from a microorganism of a genus selected from the group consisting of Schizochytrium, Thraustochytrium, Aplanochytrium, Japonochytrium, Althomia, Elina, Crypthecodinium, and Mortierella.

24. The sweetened oil composition of claim 1, wherein the oil comprising at least one LC-PUFA is a microbial oil from a microorganism of a genus selected from the group consisting of Thraustochytrium, Schizochytrium, Crypthecodinium, and Mortierella.

25. The sweetened oil composition of claim 1, wherein the oil comprising at least one LC-PUFA is a plant seed oil derived from an oil seed plant that has been genetically modified to produce long chain polyunsaturated fatty acids.

26. The sweetened oil composition of claim 1, wherein the oil comprising at least one LC-PUFA is an aquatic animal oil.

27. The sweetened oil composition of claim 1, further comprising at least one additional component selected from the group consisting of antioxidants, flavors, flavor enhancers, pigments, vitamins, minerals, prebiotic compounds, and combinations thereof.

28. A product comprising the sweetened oil composition of claim 1.

29. (canceled)

30. A method for producing a sweetened oil composition comprising contacting an oil comprising at least one LC-PUFA with a non-hydrated high-intensity sweetener in the absence of stabilizing agents to form the sweetened oil composition.

31-65. (canceled)

66. An encapsulated product comprising an oil comprising at least one LC-PUFA and a non-hydrated high-intensity sweetener, wherein the oil composition does not contain stabilizing agents.

67-93. (canceled)

94. A product comprising the encapsulated product of claim 66.

95. (canceled)

96. The sweetened oil composition of claim 1, wherein the high-intensity sweetener is a micronized sweetener.

97-105. (canceled)

106. A method for producing a sweetened oil composition comprising contacting an oil comprising at least one LC-PUFA with a micronized high-intensity sweetener to form the sweetened oil composition.

107-109. (canceled)

110. A sweetened oil composition, comprising:
an oil comprising at least one LC-PUFA, and
a high-intensity sweetener,
wherein the oil composition does not contain stabilizing agents, and wherein the sweetened oil composition has an oxidative stability index of at least about 25% greater than the oxidative stability index of the oil comprising at least one LC-PUFA.

111-130. (canceled)

131. A product comprising the sweetened oil composition of claim 110.

132. (canceled)
